(19) United States
(12) Patent Application Publication
(10) Pub. No.: US 2017/0324844 A1
(43) Pub. Date: Nov. 9, 2017

(54) Method and Apparatus for Accessing Data Traffic in a Controller Area Network

(71) Applicant: Roush Enterprises, Inc., Livonia, MI (US)

(72) Inventor: Justin G. Schroeder, South Lyon, MI (US)

(21) Appl. No.: 15/583,250

(22) Filed: May 1, 2017

Related U.S. Application Data
(60) Provisional application No. 62/331,050, filed on May 3, 2016.

(51) Int. Cl. H04L 29/06; H04L 12/40; G07C 5/00

(52) U.S. Cl. CPC H04L 69/08; H04L 69/26; H04L 12/40; G07C 5/008; H04L 69/18; H04L 2012/40215; H04L 2012/40273

(57) ABSTRACT

A method manages data traffic in a vehicle controller area network having a plurality of functional modules. To that end, the method and apparatus passively receive data messages transmitted across the controller area network. The data messages are formatted in one of a plurality of proprietary protocols. Next, the method determines the protocol of the data messages. The determined protocol is one of the plurality of proprietary protocols. After determining the protocol, protocol logic translates the data messages (transmitted across the controller area network) from the determined protocol to a given protocol. The protocol logic is configured to translate the data messages from any of the plurality of proprietary protocols into the given protocol. The method then transmits the data messages, in the given protocol, onto the controller area network for use by at least one of the functional modules.

### PRIORITY

This patent application claims priority from provisional U.S. patent application No. 62/331,050, filed May 3, 2016, entitled, “METHOD AND APPARATUS FOR ACCESSING DATA TRAFFIC IN A CONTROL AREA NETWORK,” and naming Justin G. Schroeder as inventor, the disclosure of which is incorporated herein, in its entirety, by reference.

### RELATED APPLICATION

This patent application is related to U.S. patent application Ser. No. 14/797,791, filed Jul. 13, 2015, entitled, “EXHAUST CONTROL SYSTEM,” and naming Erin M. Dmytrow, Ryan L. Martin, and Justin G. Schroeder as inventors, the disclosure of which is incorporated herein, in its entirety, by reference.

### FIELD OF THE INVENTION

The invention generally relates to vehicle intra-communication systems and, more particularly, the invention relates to managing data traffic on an internal vehicle communication system.

### BACKGROUND OF THE INVENTION

Automobile onboard diagnostics (a/k/a OBD, OBD II, OBD 2) provide an interface for various entities, such as dealers, mechanics and third parties (e.g., insurance companies or mobile application providers) to access internal computer systems. Among other things, those internal computer systems may have vehicle information, such as speed, temperatures, vehicle type, etc., that such entities may retrieve and process. Entities accessing these computer systems typically use an external device to recover the requisite information.

Undesirably, prior art techniques for accessing such information can adversely affect operation of one or more features on the vehicle. For example, a device accessing this information may disable important features, such as E911 assist, and less important features, such as information-entertainment functions. Such devices used in this manner also have the potential to 1) introduce stalling, 2) cause check engine lights or other warning indicators to illuminate, 3) set diagnostic trouble codes, and 4) impact other vehicle functionality.

### SUMMARY OF VARIOUS EMBODIMENTS

In accordance with one embodiment of the invention, a method and apparatus manage data traffic in a vehicle controller area network having a plurality of functional modules. To that end, the method and apparatus passively receive data messages transmitted across the controller area network of the vehicle. The data messages are formatted in one of a plurality of proprietary protocols. Next, the method and apparatus determine the protocol of the data messages transmitted across the controller area network. The determined protocol is one of the plurality of proprietary protocols.

After determining the protocol, protocol logic is controlled to translate the data messages (transmitted across the controller area network) from the determined protocol to a given protocol. The protocol logic thus is configured to translate the data messages from any of the plurality of proprietary protocols into the given protocol. The method and apparatus then transmit the data messages, in the given protocol, onto the controller area network for use by at least one of the functional modules.

The method and apparatus may passively receive the messages in a manner that does not forward a request for the data messages across the controller area network. Alternatively or in addition, the process of passively receiving the messages during normal vehicle operation may involve receiving messages without inhibiting the execution of the functions performed by the functional modules (during normal vehicle operation). Among other things, the functional modules may include engine control units.

The protocol logic may translate no more than a sub-set of the plurality of data messages transmitted across the control area network. In a similar manner, the data messages may be transmitted by a) determining a sub-set of data messages to transmit in the controller area network in the given protocol, and b) transmitting the sub-set of data messages in the controller area network in the given protocol.

Some embodiments may passively receive data messages via an on-board diagnostics port of the controller area network. For example, the protocol logic may include a dongle coupled with the on-board diagnostics port. Alternatively or in addition, the protocol logic may be hard-wired directly to the controller area network. Among other types, the vehicle may be an automobile, and the plurality of proprietary protocols may include a first proprietary protocol of a first automobile company, and a second proprietary protocol of a second automobile company.

An after-market party may install the apparatus and/or engage in the process of managing the data messages. To that end, an after-market party may couple the protocol logic to the vehicle to receive the data messages. As such, the vehicle is fully manufactured before the after-market party couples the protocol logic to the vehicle. Moreover, to provide further functionality, the data messages may be transmitted, in the given protocol, to an off-network apparatus having program code configured to cooperate with the at least one functional module. For example, the program code may control the functional module as a function of the data messages.

In accordance with another embodiment, an apparatus for managing data traffic in a controller area network of a vehicle with a plurality of functional modules includes a CAN interface configured to passively receive data messages transmitted across the controller area network on the vehicle. The data messages are formatted in one of a plurality of proprietary protocols. The apparatus also has 1) a protocol selector configured to determine the protocol of the data messages transmitted across the controller area network, 2) a first translation module (operatively coupled with the protocol selector) configured to translate the received data messages from a first proprietary protocol to a common given protocol, and 3) a second translation module (operatively coupled with the protocol selector) configured to translate the received data messages from a second proprietary protocol to the common given protocol. The first proprietary protocol preferably is different from the second proprietary protocol. The CAN interface is configured to transmit the data messages, in the common given protocol, onto the controller area network for use by at least one of the functional modules on the controller area network.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a vehicle network implementing one embodiment of the invention.

FIG. 2 schematically shows a second vehicle network implementing a second embodiment of the invention.

FIG. 3 schematically shows a data monitor configured to monitor data messages in a vehicle network, such as the networks of FIGS. 1 and 2, in accordance with illustrative embodiments of the invention.

FIG. 4 shows a process of monitoring data messages in vehicle networks in accordance with illustrative embodiments of the invention.

### DESCRIPTION OF ILLUSTRATIVE EMBODIMENTS

In illustrative embodiments, a data monitoring device passively monitors and translates data messages transmitted within a vehicle network (e.g., a controller area network) for use by other portions of the vehicle network. To that end, the device determines the protocol of the data messages, and then translates those messages from the determined protocol to another protocol or format that is usable by the other portions of the vehicle network (e.g., a module controlling the exhaust system). Importantly, by passively monitoring the messages, preferred embodiments of the data monitoring device do not interrogate other network components/devices, interrupt the functionality of other network components/devices, send requests for data messages, or actively interact with other network components/devices to obtain the data messages. Instead, the device simply “listens” to the data traffic in the network. Details of illustrative embodiments are discussed below.

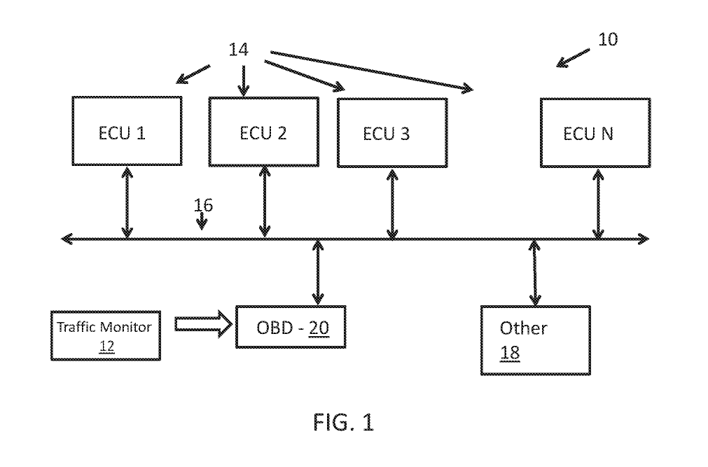

FIG. 1 schematically shows a vehicle network 10 having a traffic monitor 12 that passively monitors network data messages in accordance with illustrative embodiments of the invention. The vehicle network 10 preferably is a high speed controller area network (also known as a “CAN”) within an automobile (e.g., a car or truck). As known by those skilled in the art, a controller area network 10 is a widely-adopted vehicle network that, using a message based transmission protocol, allows microcontrollers and other devices within a vehicle to communicate without the need for a host computer.

To those ends, the network 10 of FIG. 1 includes a plurality of functional modules that together control some portion of vehicle operation—the drawings generically show those functional modules as “ECUs 14” and “Other 18.” Each of these functional modules 14 and 18 is operatively connected by a conventional interconnect mechanism. FIG. 1 simply shows a bus 16 communicating each the components. Those skilled in the art should understand that this generalized representation can be modified to include other conventional direct or indirect connections. Accordingly, discussion of a bus 16 is not intended to limit various embodiments.

The network 10 shown in FIG. 1 has “N” engine control units 14. Specifically, engine control units 14 traditionally optimize engine performance based upon readings from a plurality of sensors (e.g., satellite sensors about the periphery of the vehicle). To that end, engine control units 14 may adjust engine actuators so that the engine operates at desired performance efficiency. For example, engine control units 14 may control ignition timing, idle speed, air/fuel mixtures, transient fueling, and low fuel pressure modifiers.

The functional module labeled “other 18” may represent any of a wide variety of other functional modules. For example, this additional functional module may represent one or more similar or disparate functional modules, such as a computer or processor. As another example, the other module may also include a valve controller that controls the flow of exhaust gasses through the internal automobile exhaust system. For more information regarding this valve controller, see co-pending U.S. patent application Ser. No. 14/797,791, incorporated above.

In a manner similar to other controller area networks, the network 10 of FIG. 1 also has a mechanism for enabling a third party, such as a technician or vehicle owner, to access the various functional modules 14 and 18, as well as the network 10 itself. Accordingly, the network 10 also has a conventional onboard diagnostic connector 20 (e.g., a SAE J1962 connector using OBD, OBD II), enabling user access to various vehicle sub-systems and functional modules. Among other things, a user typically may monitor emissions, mileage, speed, and other useful data through the onboard diagnostic connector 20.

As a physical component, the onboard diagnostic connector 20 preferably has a standardized interface for receiving a complementary device. For example, the onboard diagnostic connector 20 may connect to a coupling mechanism at the end of a harness extending from a large engine testing computer system. As another example, the onboard diagnostic connector 20 may connect to a unitary, self-contained portable device, such as a dongle.

As known by those skilled in the art, a dongle typically is a small, hand-held device that can be configured to perform any of a wide variety of functions. Insurance companies often use dongles in this manner to monitor driver habits. Undesirably, prior art dongles used for these purposes typically send request messages or otherwise interrogate various specific functional modules 14 and/or 18 within the controller area network 10 to receive their required information. In addition, further compounding problems, these prior art dongles also can reduce or interfere with functionality of other important modules in the network 10. For example, some of these dongles can turn off emergency 911 call-out functionality, unnecessarily illuminating hazard lights, or prevent hazard lights from illuminating.

Recognizing these problems, the inventors developed the noted traffic monitor 12, which passively monitors network data traffic without requesting data or interfering with the functions of other modules 14 and 18 in the network 10. FIG. 1 schematically shows the traffic monitor 12, which, in this embodiment, plugs into the onboard diagnostic connector 20. The traffic monitor 12 may take on any of a wide variety of form factors, such as a stand-alone device connected through a wiring harness or similar connector, or a dongle that plugs directly into the onboard diagnostic connector 20.

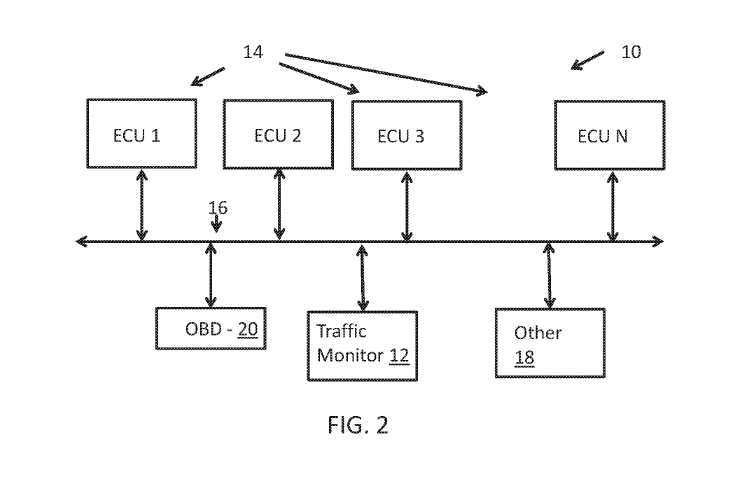

Other embodiments, however, may connect to the network 10 in other ways. For example, the traffic monitor 12 may simply transmit selected network data off-network, or to another device using wireless technology (e.g., satellite transmission, Bluetooth, WiFi, etc.). FIG. 2 schematically shows a second example of the traffic monitor 12 directly connecting to the network 10—i.e., not through the onboard diagnostic connector 20. For example, the traffic monitor 12 may be physically secured within the automobile (i.e., hardwired to the network 10), and communicate with the network bus 16 to control the exhaust valve as described in the above-noted incorporated patent application. Indeed, different vehicles may permit this hardwired connection at different locations. Those skilled in the art therefore should have knowledge of the appropriate location of the network 10 of the specific vehicle receiving the traffic monitor 12.

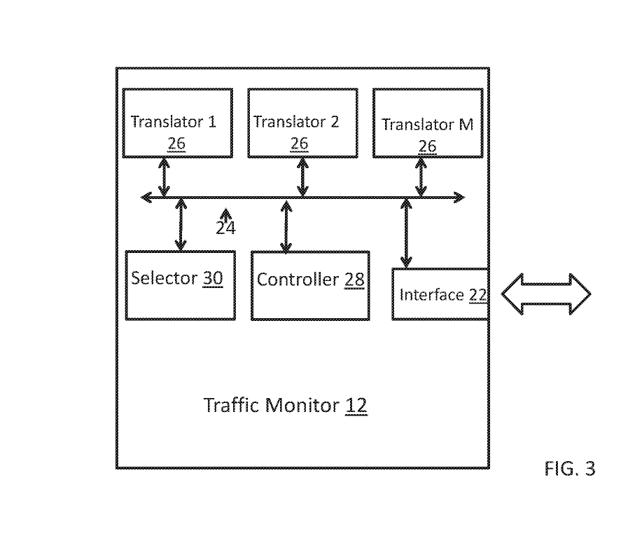

FIG. 3 schematically shows additional details of the traffic monitor 12 shown in FIGS. 1 and 2. In a manner similar to the network 10, the traffic monitor 12 includes a plurality of functional modules that cooperate to perform a variety of desired functions. Also like the network 10, each of these components is operatively connected by a conventional interconnect mechanism. FIG. 3 simply shows a bus 24 communicating each the components. Those skilled in the art should understand that this generalized representation can be modified to include other conventional direct or indirect connections. Accordingly, discussion of a bus 24 is not intended to limit various embodiments.

The traffic monitor 12 preferably enables entities that are not related to the manufacture of the vehicle access to the data. These entities often are called “aftermarket” entities, which often add or augment components or functionality to an already produced or manufactured vehicle. As known by those skilled in the art, aftermarket parts or components are not sourced from the vehicles manufacturer. For example, an aftermarket company or aftermarket service person could add an aftermarket exhaust control system like that described in the incorporated patent application.

As noted above, the traffic monitor 12 passively listens to data traffic in the network 10. To that end, the traffic monitor 12 has an interface 22 for sending and receiving data to and from the network 10, which includes passively listening to the network data traffic. As an aftermarket product, illustrative embodiments of the traffic monitor 12 are not necessarily custom-made for one particular type of vehicle. Specifically, different vehicle manufacturers commonly each have their own proprietary protocol or format for communicating information relating to operation of the vehicle. Accordingly, the traffic monitor 12 has a plurality of modules that each are capable of reading and understanding at least one such proprietary protocol.

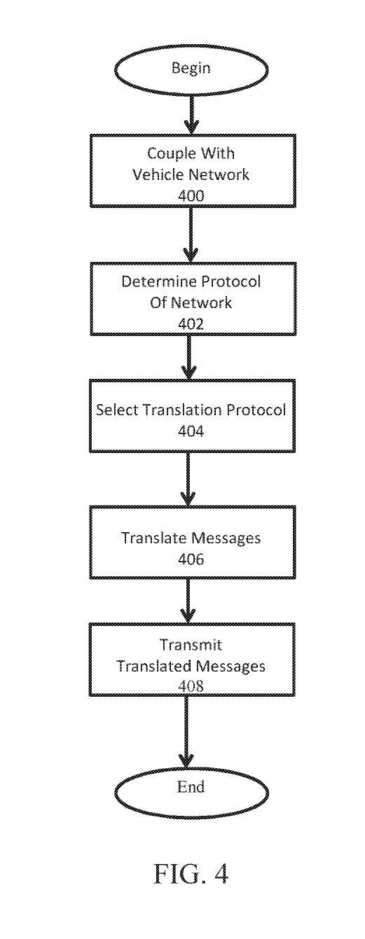

More particularly, the traffic monitor 12 has a plurality of translators (generically identified by reference number “26”) that each are configured to understand at least one proprietary protocol, and translate information from that proprietary protocol to a common protocol. For example, Translator 1 may be configured to translate the FORD™ protocol to the common protocol, while Translator 2 may be configured to translate the GENERAL MOTORS™ protocol to the same common protocol. Those skilled in the art with knowledge of the proprietary protocol can use conventional translation techniques to make those translations. As discussed below with respect to FIG. 4, a controller 28 within the traffic monitor 12 may direct the translated messages from the traffic monitor 12, through the interface 22, and onto the network 10 for use by other functional modules in the network 10.

As known by those skilled in the art, there are different types of protocols. One type of protocol may simply specify the format that messages or forwarded through the network 10 (a “transmission” protocol), while another protocol may specify the meaning of the data transmitted in the various messages across the network 10 (a “data” protocol). Accordingly, in some embodiments, for received messages, a given translator 26 may translate/decode the messages using first the transmission protocol (e.g., Ethernet) to produce the data encoded in the data protocol. Next, the given translator 26 may then translate/decode the data parsed from the messages. Then, as discussed below with regard to FIG. 4, the given translator 26 may translate/encode the translated data into the standard format (one or both of the data and the transmission protocol) for use by the ECUs 14 and/or the other devices 18.

Many modern automobiles, however, have a common transmission protocol. Accordingly, each translator 26 may use the same transmission protocol decoding technique, but use different, proprietary data protocol decoding techniques to decode the data in the messages. For example, Translator 1 may use a decoding technique common to five automobile manufacturers for decoding the messages (i.e., based on the transmission protocol), but use a single automobile manufacture decoding technique for reading the data in the message.

The traffic monitor 12 thus also has a selector 30 that determines the appropriate translator 26 based upon the message traffic. Indeed, it should be noted that FIG. 3 only schematically shows each of these components. Those skilled in the art should understand that each of these components can be implemented in a variety of conventional manners, such as by using hardware, software, or a combination of hardware and software, across one or more other functional components. For example, each translator 26 may be implemented using a plurality of microprocessors executing firmware. As another example, the translators 26 may be implemented using one or more application specific integrated circuits (i.e., “ASICs”) and related software, or a combination of ASICs, discrete electronic components (e.g., transistors), and microprocessors. Accordingly, the representation of the translators 26 and other components in a single box of FIG. 3 is for simplicity purposes only. In fact, in some embodiments, the traffic monitor 12 of FIG. 3 is distributed across a plurality of different physical platforms—not necessarily within the same housing or chassis.

Those skilled in the art should understand that the traffic monitor 12 may have many other physical and functional components, such as short-term and long term memory for locally storing translated data messages, a modem or transmitter for wirelessly transmitting translated data, and microprocessors providing further functionality. Accordingly, this discussion in no way suggests that FIG. 3 represents all of the elements of the traffic monitor 12.

FIG. 4 shows a process of monitoring data messages in vehicle networks 10 in accordance with illustrative embodiments of the invention. It should be noted that this process is simplified from a longer process that may be used to manage data messages in the controller area network 10. Accordingly, the process can have more steps. In addition, some of the steps may be performed in a different order than that shown, or at the same time. Those skilled in the art therefore can modify the process as appropriate. Moreover, although discussed in terms of the controller area network 10 shown in FIGS. 1 and 2, those skilled in the art can apply various embodiments of this process to other vehicle networks 10. In fact, those skilled in the art can apply illustrative embodiments to other types of vehicles.

The process begins at step 400, which couples the traffic monitor 12 with the network 10. For example, when using a dongle form factor, the traffic monitor 12 may be connected through the onboard diagnostic connector 20 (FIG. 1). As another example, when using a hardwired implementation, the traffic monitor 12 may be connected directly to the system as in FIG. 2. In either case, when implemented as an aftermarket technology, the vehicle preferably is fully manufactured before beginning this step. At this point, the traffic monitor 12 is electrically coupled with the network 10 and thus, may begin passively receiving data messages.

The process continues to step 402, which determines the protocol of the network 10. As noted above, the network 10 is part of a vehicle produced by a specific vehicle manufacturer that encodes its network traffic using its own proprietary protocols. Accordingly, the selector 30 determines the proprietary protocol used by the vehicle. Those skilled in the art can use any of a number of techniques for doing so. For example, the selector 30 may intercept/receive and parse data traffic to determine the proprietary protocol. As a second example, the selector 30 may engage in some other “handshake” initialization processes with other functional modules in the network 10 to determine the proprietary protocol. For example, when the vehicle starts, the controller 28 may interact with a functional module of the network 10 to determine the required information. In fact, the selector 30 may be configured to execute a series of different techniques until it is able to determine the appropriate protocol for the vehicle.

After determining the proprietary protocol, the selector 30 selects one of the plurality of translators 26 (step 404), and then enables the selected translator 26 to translate messages from the proprietary protocol to a common protocol (step 406). In illustrative embodiments, after decoding the messages and their data, the selected translator 26 encodes the decoded data into a single, common protocol. The selected translator 26 may translate all of the messages it intercepts in the network 10.

In other embodiments, however, the selected translator 26 may be configured to translate only selected messages in the network 10. For example, when used with the exhaust controlling module of the incorporated patent application, the translator 26 may be configured to translate messages relating only to parameters required by the exhaust valve controller module. Among others, those messages may include information relating to throttle position, speed, etc.

Those skilled in the art can select from any of a variety of types of messages or messages carrying selected types of data. Of course, in a manner similar to the valve controller example noted above, the type of data selected depends on the use of that data. Without limitation, that type of data may include one or more of:
Mileage,
Miles per gallon,
Location,
Vehicle identification number,
Revolutions per minute,
Acceleration,
Velocity,
Times for various activities,
Codes,
Transmission shift times, and
Warm-up time from one temperature to another temperature.

Accordingly, the controller 28, selector 30, and/or the translators 26 may be configured to selectively translate the data messages that the traffic monitor 12 passively receives.

The process concludes at step 408, in which the controller 28 transmits messages to the network 10 for use by other functional modules that understand the common protocol. For example, the controller may transmit the translated messages to the valve controller of the incorporated patent application. Those specific messages may include speed and throttle position information encoded in the common protocol. The valve controller may decode these messages and use this information to control the position of its exhaust valve.

Some embodiments may simply transmit all translated data messages (e.g., if only selected data messages were translated), or transmit selected translated data messages (e.g., if more data messages than required were translated). Other embodiments, however, may translate the data messages to off-network devices, such as to the Internet, a server or storage device across the Internet, to a cloud service, or to a computer system executing an application program. For example, a user may have an application executing a graphical user interface that displays charts and data obtained by the traffic monitor 12. In fact, this application may enable a user to control various functional modules in the network 10 as a function of the obtained data.

Rather than directly transmitting the translated data messages, some embodiments may simply broadcast the translated data messages to the network 10. Accordingly, functional modules in the network 10 may read or ignore the incoming translated data messages.

Various aftermarket implementations may be produced as a kit, having the traffic monitor 12 and necessary equipment configured to couple the traffic monitor 12 to the network 10. Accordingly, a technician or other skilled person may use the components in the kit to couple the traffic monitor 12 with the controller area network 10.

Illustrative embodiments therefore permit the traffic monitor 12 to couple with the controller area network 10 of any of a variety of different types of vehicles. Moreover, by passively receiving data traffic across the network 10, the traffic monitor 12 does not significantly add to network congestion or interfere with the operation of other functional modules in the network 10.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of managing data traffic in a controller area network of a vehicle, the controller area network having a plurality of functional modules, the method comprising:
passively receiving data messages transmitted across the controller area network of the vehicle, the data messages being formatted in one of a plurality of proprietary protocols;
determining the protocol of the data messages transmitted across the controller area network, the determined protocol being one of the plurality of proprietary protocols;
controlling protocol logic to translate the data messages transmitted across the controller area network from the determined protocol to a given protocol, the protocol logic being configured to translate the data messages from any of the plurality of proprietary protocols into the given protocol;
transmitting the data messages, in the given protocol, onto the controller area network for use by at least one of the functional modules on the controller area network.

2. The method as defined by claim 1 wherein passively receiving includes receiving the data messages without forwarding a request for the data messages across the controller area network.

3. The method as defined by claim 1 wherein the plurality of functional modules are configured to execute a plurality of module functions during normal vehicle operation, passively receiving comprising receiving the data messages during normal vehicle operation without inhibiting the execution of the module functions during normal vehicle operation.

4. The method as defined by claim 1 wherein controlling comprises controlling the protocol logic to translate no more than a sub-set of the plurality of data messages transmitted across the control area network.

5. The method as defined by claim 1 wherein transmitting the data messages comprises a) determining a sub-set of data messages to transmit in the controller area network in the given protocol, and b) transmitting the sub-set of data messages in the controller area network in the given protocol.

6. The method as defined by claim 1 wherein the controller area network includes an on-board diagnostics port, passively receiving data messages comprising receiving the data messages via the on-board diagnostics port.

7. The method as defined by claim 6 wherein the protocol logic comprises a dongle coupled with the on-board diagnostics port.

8. The method as defined by claim 1 wherein the protocol logic is hard-wired directly to the controller area network.

9. The method as defined by claim 1 wherein the vehicle is an automobile and the plurality of proprietary protocols include a first proprietary protocol of a first automobile company, and a second proprietary protocol of a second automobile company.

10. The method as defined by claim 1 wherein the plurality of functional modules includes a plurality of engine control units.

11. The method as defined by claim 1 further comprising coupling the protocol logic to the vehicle to receive the data messages, the vehicle being fully manufactured before coupling the protocol logic to the vehicle.

12. The method as defined by claim 1 further comprising transmitting the data messages, in the given protocol, to an off-network apparatus having program code configured to cooperate with the at least one functional module.

13. The method as defined by claim 1 wherein the data messages includes at least one of distance, velocity, acceleration, vehicle position, or vehicle code data.

14. An apparatus for managing data traffic in a controller area network of a vehicle, the controller area network having a plurality of functional modules, the apparatus comprising:
a CAN interface configured to passively receive data messages transmitted across the controller area network on the vehicle, the data messages being formatted in one of a plurality of proprietary protocols;
a protocol selector configured to determine the protocol of the data messages transmitted across the controller area network;
a first translation module operatively coupled with the protocol selector, the first translation module being configured to translate the received data messages from a first proprietary protocol to a common given protocol;
a second translation module operatively coupled with the protocol selector, the second translation module being configured to translate the received data messages from a second proprietary protocol to the common given protocol,
the first proprietary protocol being different from the second proprietary protocol,
the CAN interface being configured to transmit the data messages, in the common given protocol, onto the controller area network for use by at least one of the functional modules on the controller area network.

15. The apparatus as defined by claim 14 wherein the CAN interface is configured to receive the data messages without forwarding a request for the data messages across the controller area network.

16. The apparatus as defined by claim 14 wherein the plurality of functional modules are configured to execute a plurality of module functions during normal vehicle operation, the CAN interface being configured to receive the data messages during normal vehicle operation without inhibiting the execution of the module functions during normal vehicle operation.

17. The apparatus as defined by claim 14 wherein the translation modules are configured so that no more than one of the first translation module and the second translation module translate the received data messages.

18. The apparatus as defined by claim 17 wherein each of the first and second translation module is configured to translate no more than a sub-set of the received data messages for transmission from the CAN interface across the control area network.

19. The apparatus as defined by claim 14 wherein the controller area network includes an on-board diagnostics port, the CAN interface being electronically coupled with the on-board diagnostics port.

20. The apparatus as defined by claim 19 wherein the CAN interface and translation modules comprise a dongle physically coupled with the on-board diagnostics port.

21. The apparatus as defined by claim 14 wherein the CAN interface and translation modules are hard-wired directly to the controller area network.

22. The apparatus as defined by claim 14 wherein the vehicle is an automobile, the first proprietary protocol comprises a protocol of a first automobile company, and the second proprietary protocol comprises a protocol of a second automobile company.

23. The apparatus as defined by claim 14 wherein the plurality of functional modules includes a plurality of engine control units.

24. The apparatus as defined by claim 14 further comprising an off-network apparatus having an input for receiving the data messages in the common given protocol, and program code configured to cooperate with the at least one functional module.

25. A computer program product for use on a computer system for managing data traffic in a controller area network of a vehicle, the controller area network having a plurality of functional modules, the computer program product comprising a tangible, non-transient computer usable medium having computer readable program code thereon, the computer readable program code comprising:
program code for passively receiving data messages transmitted across the controller area network of the vehicle, the data messages being formatted in one of a plurality of proprietary protocols;
program code for determining the protocol of the data messages transmitted across the controller area network, the determined protocol being one of the plurality of proprietary protocols;
program code for translating the data messages transmitted across the controller area network from the determined protocol to a given protocol, the program code for translating being configured to translate the data messages from any of the plurality of proprietary protocols into the given protocol;
program code for transmitting the data messages, in the given protocol, onto the controller area network for use by at least one of the functional modules on the controller area network.

26. The computer program product as defined by claim 25 wherein the program code for passively receiving includes program code for receiving the data messages without forwarding a request for the data messages across the controller area network.

27. The computer program product as defined by claim 25 wherein the plurality of functional modules are configured to execute a plurality of module functions during normal vehicle operation, the program code for passively receiving comprising program code for receiving the data messages during normal vehicle operation without inhibiting the execution of the module functions during normal vehicle operation.

28. The computer program product as defined by claim 25 wherein the program code for translating comprises program code for translating no more than a sub-set of the plurality of data messages transmitted across the control area network.

29. The computer program product as defined by claim 25 wherein program code for transmitting the data messages comprises a) program code for determining a sub-set of data messages to transmit in the controller area network in the given protocol, and b) program code for transmitting the sub-set of data messages in the controller area network in the given protocol.
